(19) United States
(12) Patent Application Publication
(10) Pub. No.: US 2012/0002982 A1
(43) Pub. Date: Jan. 5, 2012

(54) IMAGE FORMING APPARATUS AND IMAGE FORMING METHOD

(75) Inventor: Junichi Katayama, Shizuoka (JP)

(73) Assignees: Toshiba Tec Kabushiki Kaisha, Tokyo (JP); Kabushiki Kaisha Toshiba, Tokyo (JP)

(21) Appl. No.: 13/170,036

(22) Filed: Jun. 27, 2011

Related U.S. Application Data
(60) Provisional application No. 61/361,363, filed on Jul. 2, 2010.

(51) Int. Cl. G03G 15/00

(52) U.S. Cl. 399/12

(57) ABSTRACT

Certain embodiment provide an image forming apparatus including an image forming unit configured to form, if a toner cartridge used in single-color printing is a non-genuine product or if at least one of plural toner cartridges used in plural-color printing is a non-genuine product and the plural-color printing is selected, a copy image in an image quality priority mode for executing, at a frequency higher than that in a normal mode, image quality maintenance control for maintaining the copy image in desired image quality.

### CROSS-REFERENCE TO RELATED APPLICATION

This application is based upon and claims the benefit of priority from Provisional U.S. Application 61/361,363 filed on Jul. 2, 2010, the entire contents of which are incorporated herein by reference.

### FIELD

Embodiments described herein relate generally to an image forming apparatus and an image forming method.

### BACKGROUND

A toner cartridge used in an image forming apparatus is a consumable component. When a toner in the toner cartridge is exhausted, the toner cartridge needs to be replaced with a new toner cartridge. If a toner cartridge (a genuine product) provided by a manufacturer of the image forming apparatus is used, the quality of a copy image is guaranteed. However, if a toner cartridge (a non-genuine product) provided another company is used, the quality of a copy image is not guaranteed.

As means for solving this problem, there is known an image forming apparatus that increases, if a non-genuine toner cartridge is used, a frequency of execution of image quality maintenance control for keeping the quality of copy images at fixed quality to be higher than a frequency of the image quality maintenance control executed when a genuine toner cartridge is used.

For example, it is assumed that, if the genuine toner cartridge is used, the image forming apparatus is executing the image quality maintenance control every time one thousand copy images are formed. If the non-genuine toner cartridge is used in the image forming apparatus, the image forming apparatus increases the frequency of execution of the image quality maintenance control and executes the image quality maintenance control every time one copy image is formed.

However, even if the image forming apparatus forms a monochrome copy image (the image quality maintenance control is unnecessary) when a black (B) cartridge is a genuine product and any one of yellow (Y), magenta (M), and cyan (C) cartridges is a non-genuine product, the image forming apparatus increases the frequency of execution of the image quality maintenance control.

The image forming apparatus forms a copy image after executing the image quality maintenance control. Therefore, if the frequency of executing the image quality maintenance control is increased regardless of the fact that the image quality maintenance control is unnecessary, waiting time for a user until a copy image is formed after an original document is read increases.

### DESCRIPTION OF THE DRAWINGS

FIG. 1 is a schematic diagram of an image forming apparatus according to an embodiment;

FIG. 2A is an enlarged schematic perspective view of a toner cartridge;

FIG. 2B is an enlarged schematic perspective view of a toner cartridge;

FIG. 3 is a block diagram of a control system of a color copying machine configured to mainly perform image quality maintenance control;

FIG. 4 is a flowchart for explaining an image forming method according to the embodiment, wherein all toner cartridges are genuine products;

FIG. 5 is a flowchart for explaining the image forming method according to the embodiment, wherein a black (K) toner cartridge is a non-genuine product;

FIG. 6 is a flowchart for explaining the image forming method according to the embodiment, wherein the black (K) toner cartridge is a genuine product and at least one of yellow (Y), magenta (M), and cyan (C) toner cartridges is a non-genuine product;

FIG. 7 is a flowchart for explaining a density adjusting method performed as the image quality maintenance control;

FIG. 8 is a diagram for explaining a patch according to the embodiment; and

FIG. 9 is a diagram for explaining a relation between image density and a detection value of a density sensor in the embodiment.

### DETAILED DESCRIPTION

In general, according to one embodiment, an image forming apparatus includes plural toner cartridges, a discriminating unit, a printing-mode selecting unit, and an image forming unit. The plural toner cartridges include therein toners of colors different from one another. The discriminating unit discriminates whether the plural toner cartridges are respectively genuine products. The printing-mode selecting unit selects single-color printing for forming a copy image formed of a single color or plural-color printing for forming a copy image formed of plural colors. The image forming unit forms a copy image in an image quality priority mode for executing, at a frequency higher than that in a normal mode, image quality maintenance control for maintaining copy images in desired image quality if the discriminating unit discriminates that the toner cartridge used in the single-color printing is a non-genuine product or if the discriminating unit discriminates that at least one of the plural toner cartridges used in the plural-color printing is a non-genuine product and the printing-mode selecting unit selects the plural-color printing.

In general, according to another embodiment, an image forming method includes discriminating plural toner cartridges, selecting a printing mode, and forming a copy image. The discriminating plural toner cartridges includes discriminating whether plural toner cartridges including therein toners of colors different from one another are respectively genuine products. The selecting a printing mode includes selecting single-color printing for forming a copy image formed of a single color or plural-color printing for forming a copy image formed of plural colors. The forming a copy image includes forming a copy image in an image quality priority mode for executing, at a frequency higher than that in a normal mode, image quality maintenance control for maintaining copy images in desired image quality if it is discriminated that the toner cartridge used in the single-color printing is a non-genuine product or if it is discriminated that at least one of the plural toner cartridges used in the plural-color printing is a non-genuine product and the plural-color printing is selected.

An image forming apparatus and an image forming method according to an embodiment are explained below.

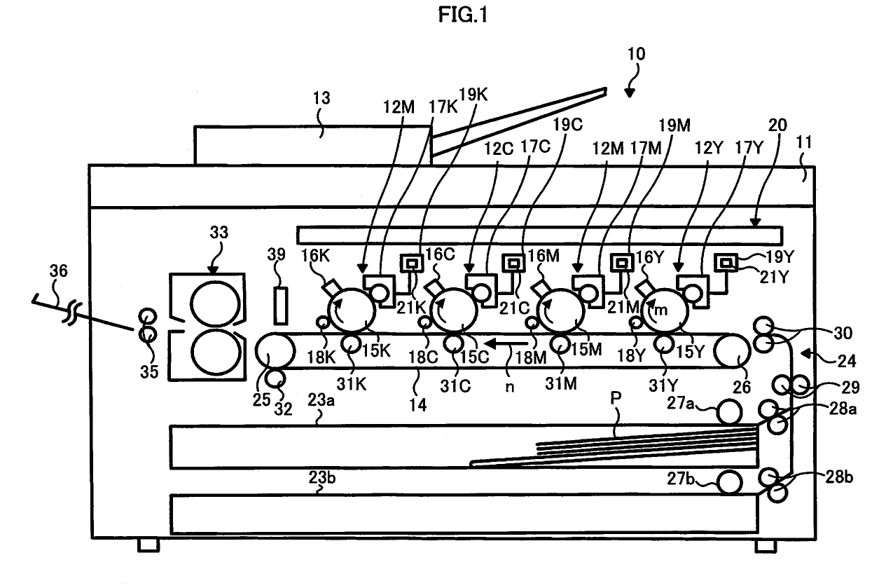

FIG. 1 is a schematic diagram of the image forming apparatus according to the embodiment. The image forming apparatus is a color copying machine of a quadruple tandem system.

A color copying machine 10 shown in FIG. 1 includes a scanner unit 11 and an image forming unit. The scanner unit 11 reads an original document fed by an auto document feeder 13 and forms image data based on the read original document.

The image forming unit includes plural image forming stations 12Y, 12M, 12C, and 12K and an exposing device 20.

The plural image forming stations 12Y, 12M, 12C, and 12K are four sets of image forming stations for yellow (Y), magenta (M), cyan (C), and black (K) and arranged in parallel along a transfer belt 14 explained later. The plural image forming stations 12Y, 12M, 12C, and 12K form a copy image obtained by superimposing toner images of plural colors one on top of another on a sheet P. However, the plural image forming stations 12Y, 12M, 12C, and 12K can form density adjustment patterns on the transfer belt 14 as well.

The image forming stations 12Y, 12M, 12C, and 12K respectively include photoconductive drums 15Y, 15M, 15C, and 15K, which are image bearing members. The photoconductive drums 15Y, 15M, 15C, and 15K are arranged such that rotation axes thereof face a direction (a main scanning direction) orthogonal to a traveling direction in an arrow n direction of the transfer belt 14 explained later (a sub-scanning direction). The rotation axes of the respective photoconductive drums 15Y, 15M, 15C, and 15K are arranged at equal intervals from one another.

The image forming stations 12Y, 12M, 12C, and 12K include, around the photoconductive drums 15Y, 15M, 15C, and 15K, electrifying chargers 16Y, 16M, 16C, and 16K, developing devices 17Y, 17M, 17C, and 17K, and photoconductive member cleaners 18Y, 18M, 18C, and 18K. The electrifying chargers 16Y, 16M, 16C, and 16K, the developing devices 17Y, 17M, 17C, and 17K, and the photoconductive member cleaners 18Y, 18M, 18C, and 18K are arranged in this order along a rotating direction of the photoconductive drums 15Y, 15M, 15C, and 15K (an arrow m direction in the figure).

Toner cartridges 19Y, 19M, 19C, and 19K are connected to the developing devices 17Y, 17M, 17C, and 17K for the respective colors. The toner cartridges 19Y, 19M, 19C, and 19K supply toners into the developing devices 17Y, 17M, 17C, and 17K for the respective colors.

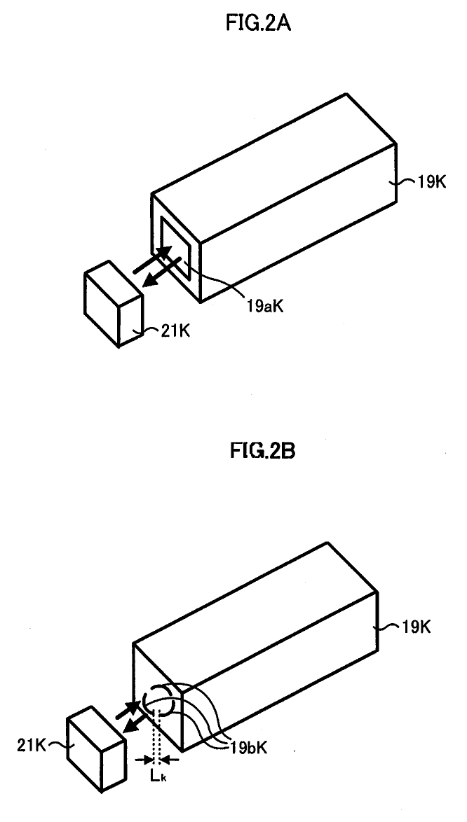

FIG. 2A is an enlarged schematic perspective view of a toner cartridge. The toner cartridge shown in FIG. 2A is the toner cartridge 19K for black (K). However, the toner cartridges 19Y, 19M, and 19C for the other colors are the same.

As shown in FIG. 2A, in order to discriminate that the toner cartridge 19K is a genuine product, the toner cartridge 19K includes, on an end face thereof, a memory chip 19aK in which product information indicating that the toner cartridge 19K is the genuine product is stored.

As shown in FIGS. 1 and 2A, the color copying machine 10 includes cartridge discrimination sensors 21Y, 21M, 21C, and 21K for reading product information stored in memory chips 19aY, 19aM, 19aC, and 19aK. The cartridge discrimination sensor 21K is provided in a position opposed to the memory chip 19aK in the color copying machine 10. The other cartridge discrimination sensors 21Y, 21M, and 21C are provided in the same manner.

The cartridge discrimination sensors 21Y, 21M, 21C, and 21K read product information stored in the memory chips 19aY, 19aM, 19aC, and 19aK, whereby a CPU 40 explained later discriminates whether the toner cartridge 19K is a genuine product.

FIG. 2B is an enlarged schematic perspective view of another toner cartridge. As shown in FIG. 2B, the toner cartridge 19K may include plural convex portions 19bK on the end face thereof. In this case, the cartridge discrimination sensor 21K measures, for example, a distance Lₖ among the convex portions 19bK. A reference value of the distance Lₖ among the convex portions 19bK provided in the genuine toner cartridge 19K is stored in, for example, a ROM 47-1 explained later. The CPU 40 explained later compares the reference value and a distance measured by the cartridge discrimination sensor 21K to thereby discriminate whether the toner cartridge 19K is a genuine product.

A plurality of the convex portions 19bK shown in FIG. 2B may be provided in each of the other toner cartridges 19Y, 19M, and 19C.

As shown in FIG. 1, the exposing device 20 includes laser oscillators for the respective colors and mirrors for leading laser beams of the respective colors to predetermined positions. The exposing device 20 is arranged on the image forming stations 12Y, 12M, 12C, and 12K.

The exposing device 20 emits laser beams having desired intensities based on image data formed by the scanner unit 11 and leads the emitted laser beams to desired positions based on the image data on the surfaces of the respective photoconductive drums 15Y, 15M, 15C, and 15K. The surfaces of the photoconductive drums 15Y, 15M, 15C, and 15K are uniformly charged by the electrifying chargers 16Y, 16M, 16C, and 16K. When the exposing device 20 irradiates the laser beams on the surfaces of the photoconductive drums 15Y, 15M, 15C, and 15K, electrostatic latent images, which are charged to attract toners in the developing devices 17Y, 17M, 17C, and 17K, are formed on the surfaces of the photoconductive drums 15Y, 15M, 15C, and 15K. The developing devices 17Y, 17M, 17C, and 17K supply the charged toners to the surfaces of the respective photoconductive drums 15Y, 15M, 15C, and 15K and form toner images of respective color components that match the electrostatic latent images.

The color copying machine 10 includes first and second paper feeding cassettes 23a and 23b including sheets P and a conveying unit 24 configured to convey the sheets P. The conveying unit 24 includes a transfer belt 14, a driving roller 25, a driven roller 26, pickup rollers 27a and 27b, separating and conveying rollers 28a and 28b, a conveying roller 29, and a registration roller 30. The pickup rollers 27a and 27b pick up the sheet P from the first and second paper feeding cassettes 23a and 23b provided in the color copying machine 10. The separating and conveying rollers 28a and 28b, the conveying roller 29, and the registration roller 30 convey the sheet P, which is picked up from the first and second paper feeding cassettes 23a and 23b, onto the transfer belt 14. The transfer belt 14, the driving roller 25, and the driven roller 26 rotate in an arrow n direction to thereby convey the sheet P on the transfer belt 14 in the arrow n direction.

The color copying machine 10 includes four transfer rollers 31Y, 31M, 31C, and 31K, which are transfer units. The four transfer rollers 31Y, 31M, 31C, and 31K respectively correspond to the photoconductive drums 15Y, 15M, 15C, and 15K and are respectively provided in positions opposed to the photoconductive drums 15Y, 15M, 15C, and 15K across the transfer belt 14. The transfer rollers 31Y, 31M, 31C, and 31K transfer the toner images on the photoconductive drums 15Y, 15M, 15C, and 15K onto the sheet P conveyed in the arrow n direction or the transfer belt 14 rotating in the arrow n direction. After the toner images are transferred, the photoconductive member cleaners 18Y, 18M, 18C, and 18K clean the toners remaining on the photoconductive drums 15Y, 15M, 15C, and 15K. Further, when the density adjustment patterns are transferred onto the transfer belt 14, a belt cleaner 32 of the color copying machine 10 removes the density adjustment patterns on the transfer belt 14.

The color copying machine 10 includes a fixing device 33. The fixing device 33 fixes a copy image, which is formed on the sheet P, on the sheet P.

The color copying machine 10 includes a paper discharge roller 35 and a paper discharge tray 36. The paper discharge roller 35 discharges the sheet P, on which the copy image is fixed, to the paper discharge tray 36.

The color copying machine 10 includes a toner adhesion amount sensor 39, which is a density detecting unit configured to detect the density of a toner image. The toner adhesion amount sensor 39 is provided on the transfer belt 14 between the image forming station 12K for black (K) and the fixing device 33.

The toner adhesion amount sensor 39 detects density adjustment patterns of the respective colors formed on the transfer belt 14. A detection result is used for density correction for toner images of the respective colors transferred onto the sheet P.

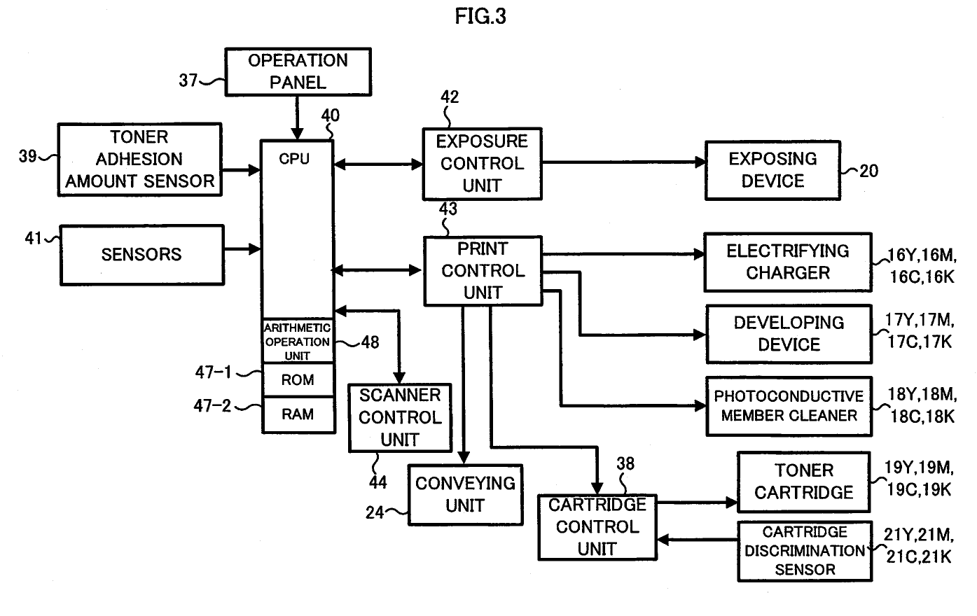

FIG. 3 is a block diagram of a control system of the color copying machine 10 configured to mainly perform image quality maintenance control. The color copying machine 10 performs, as the image quality maintenance control, cleaning of the photoconductive drums 15Y, 15M, 15C, and 15K or density adjustment for toner images of the respective colors.

The control system includes the CPU 40 configured to control the entire color copying machine 10. The toner adhesion amount sensor 39, other sensors 41 necessary for image formation, and an operation panel 37 are connected to the CPU 40. The operation panel 37 gives a command to the CPU 40 such that the color copying machine 10 performs a desired operation according to operation by a user.

The operation panel 37 displays, to the user, printing modes such as single-color printing (hereinafter referred tows monochrome printing) for forming a copy image formed of a single color and plural-color printing (hereinafter referred to as color printing) for forming a copy image formed of plural colors. The user selects one of the printing modes to thereby cause the color copying machine 10 to form a selected copy image. In other words, the operation panel 37 functions as a printing-mode selecting unit.

An exposure control unit 42, a print control unit 43, and a scanner control unit 44 are connected to the CPU 40.

The exposure control unit 42 controls the exposing device 20 such that laser beams to be emitted are emitted at desired intensities.

The print control unit 43 controls the electrifying chargers 16Y, 16M, 16C, and 16K. The controlled electrifying chargers 16Y, 16M, 16C, and 16K charge the surfaces of the photoconductive drums 15Y, 15M, 15C, and 15K for the respective colors to desired potential.

The print control unit 43 controls the developing devices 17Y, 17M, 17C, and 17K. The controlled developing devices 17Y, 17M, 17C, and 17K charge the toners stored in the developing devices 17Y, 17M, 17C, and 17K to desired charge amounts.

The print control unit 43 controls a cartridge control unit 38. The controlled cartridge control unit supplies desired amounts of toners from the toner cartridges 19Y, 19M, 19C, and 19K into the developing devices 17Y, 17M, 17C, and 17K.

Besides controlling the toner cartridges 19Y, 19M, 19C, and 19K, the cartridge control unit 38 receives results of detection of the memory chips 19aY, 19aM, 19aC, and 19aK or plural convex portions 19bY, 19bM, 19bC, and 19bK by the cartridge discrimination sensors 21Y, 21M, 21C, and 21K. The CPU 40 compares the detection results and discrimination information stored in the ROM 47-1 for discriminating whether the toner cartridges 19Y, 19M, 19C, and 19K are genuine products to thereby discriminate whether the toner cartridges 19Y, 19M, 19C, and 19K are genuine products. In this way, the CPU 40 further functions as a discriminating unit configured to discriminate whether the toner cartridges 19Y, 19M, 19C, and 19K are genuine products.

Further, the print control unit 43 controls the photoconductive member cleaners 18Y, 18M, 18C, and 18K and the conveying unit 24.

The scanner control unit 44 controls the scanner unit 11 including the auto document feeder 13.

The CPU 40 includes a memory including a ROM 47-1 and a RAM 47-2. The ROM 47-1 has stored therein discrimination information for discriminating whether the toner cartridges 19Y, 19M, 19C, and 19K are genuine products. If the memory chips 19aY, 19aM, 19aC, and 19aK are provided in the toner cartridges 19Y, 19M, 19C, and 19K as shown in FIG. 2A, the discrimination information is product information concerning genuine products. If the convex portions 19bY, 19bM, 19bC, and 19bK are provided in the toner cartridges 19Y, 19M, 19C, and 19K as shown in FIG. 2B, the discrimination information is reference values of distances among the convex portions 19bY, 19bM, 19bC, and 19bK.

The ROM 47-1 has stored therein a start condition for executing the image quality management control. The start condition is a condition for executing the image quality maintenance control, for example, if the color copying machine 10 forms a copy image in a normal mode, the image quality maintenance control is executed every time one thousand copy images are formed and, if the color copying machine 10 forms a copy image in an image quality priority mode, the image quality maintenance control is executed every time one copy image is formed. For example, the start condition is stored as “1000” in the case of the normal mode and stored as “10” in the case of the image quality priority mode. The start condition is freely set by the user. Usually, the start condition for the image quality priority mode is set smaller than the start condition for the normal mode.

Further, the ROM 47-1 has stored therein density adjustment pattern information for forming density adjustment patterns for performing density adjustment for toner images of the respective colors, a target range of the density of the density adjustment patterns, and a control program for the entire color copying machine 10.

The RAM 47-2 stores the number of original documents read by the scanner unit 11 at a time (the number of original documents), the number of copy images formed by the image forming stations 12Y, 12M, 12C, and 12K (the number of printed sheets), and a cumulative number of copy images formed by the image forming stations 12Y, 12M, 12C, and 12K (a cumulative number of printed sheets). The number of printed sheets and the cumulative number of printed sheets are incremented by one every time a copy image is formed. The number of printed sheets is reset when the number of printed sheets reaches the number of original documents. The cumulative number of printed sheets is reset when the cumulative number of printed sheets meets the start condition for the image quality maintenance control explained later.

The RAM 47-2 stores density adjustment values for controlling the laser control unit 42 and the print control unit 43 to adjust the densities of the toner images of the respective colors to desired densities.

The density adjustment values include development bias values for adjusting charge amounts of the toners in the developing devices 17Y, 17M, 17C, and 17K for the respective colors, charging bias values for adjusting the potentials of the surfaces of the photoconductive drums 15Y, 15M, 15C, and 15K for the respective colors, and laser power adjustment values for adjusting the intensities of laser beams irradiated on the surfaces of the photoconductive drums 15Y, 15M, 15C, and 15K for the respective colors.

When the CPU 40 supplies the development bias values to the print control unit 43, the print control unit 43 controls the developing devices 17Y, 17M, 17C, and 17K on the basis of the development bias values to charge the toners.

When the CPU 40 supplies the charging bias values to the print control unit 43, the print control unit 43 controls the electrifying chargers 16Y, 16M, 16C, and 16K on the basis of the charging bias values to uniformly charge the surfaces of the photoconductive drums 15Y, 15M, 15C, and 15K for the respective colors.

When the CPU 40 supplies the laser power adjustment values to the exposure control unit 42, the exposure control unit 42 controls the exposing device 20 on the basis of the laser power adjustment values to emit laser beams having predetermined intensities.

The RAM 47-2 further stores, besides the above, for example, image data formed by the scanner unit 11.

The CPU 40 includes an arithmetic operation unit 48. The arithmetic operation unit 48 calculates density adjustment values on the basis of detection results of the toner adhesion amount sensor 39. The arithmetic operation unit 48 calculates the density adjustment values using detection results of patches of the respective colors formed on the transfer belt 14 and acquires the density adjustment values. The obtained density adjustment values are set in the developing devices 17Y, 17M, 17C, and 17K, the electrifying chargers 16Y, 16M, 16C, and 16K, and the exposing device 20.

The CPU 40 controls the scanner control unit 44, the exposure control unit 42, and the print control unit 43 to thereby form a copy image on the sheet P and form density adjustment patterns on the transfer belt 14.

An image forming method according to this embodiment is explained. The image forming method is a method of selecting the image quality priority mode as the image forming mode and forming a copy image if the color printing mode is selected when the toner cartridge 19K is a non-genuine product or when at least one of the toner cartridges 19Y, 19M, and 19C is a non-genuine product. In the case other than the above, the normal mode is selected as the image forming mode and a copy image is formed. The frequency of the image quality maintenance control is higher in the image quality priority mode than in the normal mode.

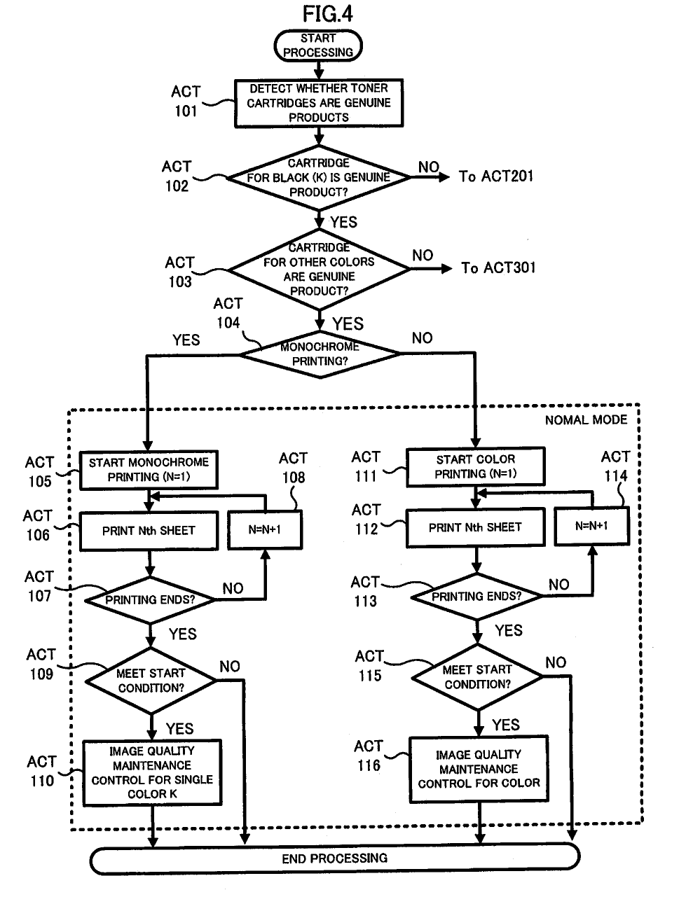

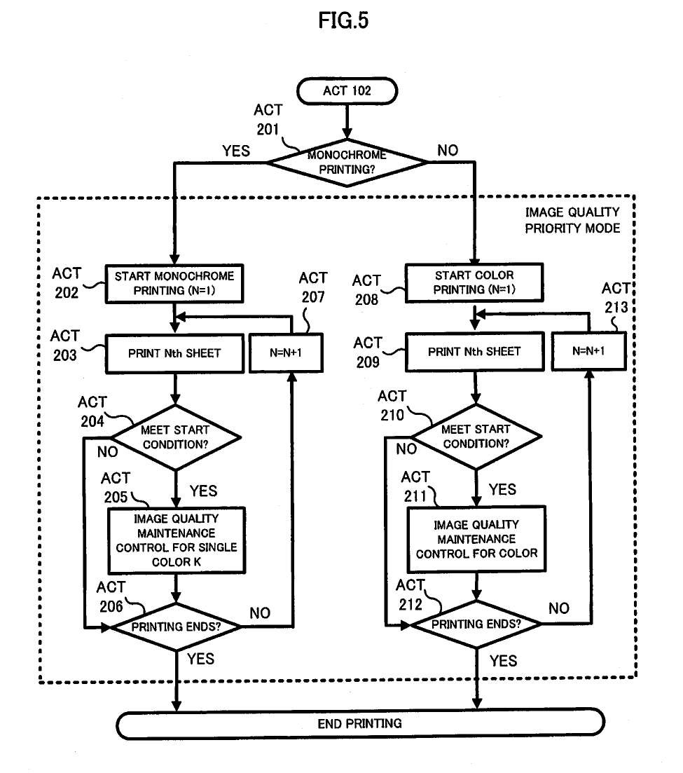

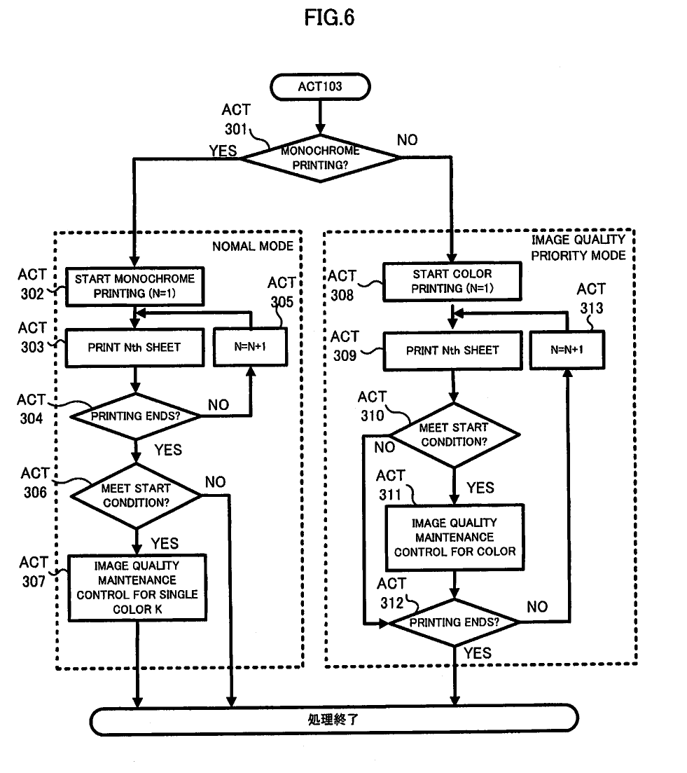

The image forming method is explained in detail below with reference to FIGS. 4 to 6. FIGS. 4 to 6 are flowcharts for explaining the image forming method according to this embodiment. FIG. 4 is a flowchart for explaining the image forming method performed if all the toner cartridges 19Y, 19M, 19C, and 19K are genuine products. FIG. 5 is a flowchart for explaining the image forming method performed if the toner cartridge 19K for black (K) is a non-genuine product. FIG. 6 is a flowchart for explaining the image forming method performed if the toner cartridge 19K is a genuine product and at least one of the toner cartridges 19Y, 19M, and 19C is a non-genuine product. The flowcharts explained below are executed by the CUP 40 reading out the control program stored in the ROM 47-1.

First, the image forming method performed if all the toner cartridges 19Y, 19M, 19C, and 19K are genuine products is explained with reference to FIG. 4.

As shown in FIG. 4, first, the scanner unit 11 forms image data of an original document. When the printing mode (the monochrome printing mode or the color printing mode) is selected by the operation of the operation panel 37 by the user, the cartridge discrimination sensors 21Y, 21M, 21C, and 21K detect, for example, the memory chips 19aY, 19aM, 19aC, and 19aK (Act 101).

Subsequently, the CPU 40 discriminates, on the basis of a result of the detection in Act 101, whether the toner cartridge 19K for black (K) is a genuine product (Act 102). The discrimination of the toner cartridge 19K is performed by comparing the result of the detection in Act 101 and the discrimination information stored in the ROM 47-1.

If the toner cartridge 19K is a non-genuine product (NO in Act 102), the CPU 40 proceeds to Act 201 explained later.

If the toner cartridge 19K is a genuine product (YES in Act 102), the CPU 40 discriminates, on the basis of the result of the detection in Act 101, whether the toner cartridges 19Y, 19M, and 19C for yellow (Y), magenta (M), and cyan (C) are respectively genuine products (Act 103).

If at least one of the toner cartridges 19Y, 19M, and 19C is a non-genuine product (NO in Act 103), the CPU 40 proceeds to Act 301 explained later.

If all the toner cartridges 19Y, 19M, and 19C are genuine products (YES in Act 103), the CPU 40 discriminates whether the printing mode is the monochrome printing mode (Act 104).

The discrimination of the printing mode is performed by receiving, from the operation panel 37, information concerning the printing mode selected by the user.

If all the toner cartridges 19Y, 19M, 19C, and 19K are genuine products, a copy image is formed in the normal mode irrespective of whether the printing mode is the monochrome printing mode or the color printing mode. A method of forming a copy image in the normal mode is explained below.

If the printing mode is the monochrome printing mode as a result of the discrimination of the printing mode in Act 104 (YES in Act 104), the color copying machine 10 starts monochrome printing for a first sheet (Act 105).

When the CPU 40 executes the monochrome printing for the first sheet (when N=1 in Act 106) and a monochrome copy image is formed, the CPU 40 determines whether printing ends (Act 107).

The present number of printed sheet N stored in the RAM 47-2 and the number of original documents are compared. The determination is performed on the basis of whether the number of printed sheets N coincides with the number of original documents.

For example, if the number of original documents is 10, the number of printed documents N=1 does not coincide with the number of original documents of 10. Therefore, the CPU 40 determines that the printing does not end (NO in Act 107). In this case, the CPU 40 updates the number of printed sheets N=1 stored in the RAM 47-2 to N=1+1 (Act 108) and executes monochrome printing for a second sheet (N=2 in Act 106). At this point, the cumulative number of printed sheets is also incremented by one.

The CPU 40 repeats Acts 107, 108, and 106. If the number of printed sheets reaches the number of original documents, the CPU 40 determines that the printing ends (YES in Act 107).

For example, if the number of original documents is 10, when the number of printed sheets N is 10, the number of printed sheets N=10 coincides with the number of original documents of 10. Therefore, the CPU 40 determines that the printing ends.

If printing for the number of original documents (e.g., 10) ends, the CPU 40 determines whether the cumulative number of printed sheets stored in the RAM 47-2 meets the start condition for the image quality maintenance control (Act 109).

The present cumulative number of printed sheets stored in the RAM 47-2 and the start condition stored in the ROM 47-1 are compared. The determination is performed on the basis of whether the cumulative number of printed sheets is equal to or larger than the start condition.

If the cumulative number of printed sheets is equal to or larger than the start condition (YES in Act 109), the CPU 10 executes the image quality maintenance control for black (K) (Act 110) and ends the printing processing. When the image quality maintenance control is executed, the cumulative number of printed sheets is reset. When the printing processing is ended, the number of original documents and the number of printed sheets are reset.

For example, when the start condition in the normal mode is 1000 and the cumulative number of printed sheets is 1005, since the cumulative number of printed sheets is equal to or larger than the start condition, the CPU 40 executes the image quality maintenance control and ends the processing. Since the image quality maintenance control is executed, the cumulative number of printed sheets is reset to zero. Since the printing processing is ended, the number of original documents and the number of printed sheets are reset to zero.

If the cumulative number of printed sheets is smaller than the start condition (NO in Act 109), the CPU 40 ends the printing processing without executing the image quality maintenance control. If the image quality maintenance control is not executed, the cumulative number of printed sheets is not reset. If the printing processing is ended, the number of original documents and the number of printed sheets are reset.

For example, if the start condition in the normal mode is 1000 and the cumulative number of printed sheets is 900, since the cumulative number of printed sheets is smaller than the start condition, the image quality maintenance control is not executed. Since the image quality maintenance control is not executed, the cumulative number of printed sheets of 900 is maintained. Since the printing processing is ended, the number of original documents and the number of printed sheets are reset to zero.

If the printing mode is the color printing mode as a result of the discrimination of the printing mode in Act 104, the color copying machine 10 forms a color copy image in the normal mode in the same manner as in the monochrome printing mode.

Specifically, the color copying machine 10 starts color printing for a first sheet (Act 111) and the CPU 40 executes the color printing for the first sheet (Act 112). Then, the CPU 40 determines whether the printing ends (Act 113). If it is determined that the printing does not end (NO in Act 113), the CPU 40 updates the number of printed sheets of 1 stored in the RAM 47-2 to 1+1 (Act 114) and, at the same time, increments the cumulative number of printed sheets by one. The CPU 40 repeats Acts 114, 112, and 113 until it is determined in Act 113 that the printing ends. If it is determined as a result of the determination that the printing ends (YES in Act 113), the CPU 40 determines whether the cumulative number of printed sheets is equal to or larger than the start condition for the image quality maintenance control (Act 115). If the cumulative number of printed sheets is equal to or larger than the start condition for the image quality maintenance control (YES in Act 115), the CPU 40 executes the image quality maintenance control for the colors (yellow (Y), magenta (M), and cyan (C)) (Act 116) and ends the printing processing. If the cumulative number of printed sheets is smaller than the start condition for the image quality maintenance control (NO in Act 115), the CPU 40 ends the printing processing without executing the image quality maintenance control.

The image forming method performed if the toner cartridge 19K for black (K) is a non-genuine product is explained with reference to FIG. 5.

If it is determined as a result of the discrimination in Act 102 shown in FIG. 4 that the toner cartridge 19K is a non-genuine product (NO in Act 102), as shown in FIG. 5, the CPU 40 discriminates whether the printing mode is the monochrome printing mode (Act 201).

If the toner cartridge 19K for black (K) is a non-genuine product, the color copying machine 10 forms a copy image in the image quality priority mode irrespective of whether the printing mode is the monochrome printing mode or the color printing mode. A method of forming a copy image in the image quality priority mode is explained below.

If the printing mode is the monochrome printing mode as a result of the discrimination of the printing mode in Act 201 (YES in Act 201), the color copying machine 10 starts monochrome printing for a first sheet (Act 202).

When the CPU 40 executes the monochrome printing for the first sheet (when N=1 in Act 203) and a monochrome copy image is formed, the CPU 40 determines whether the cumulative number of printed sheets stored in the RAM 47-2 meets the start condition for the image quality maintenance control (Act 204).

If the cumulative number of printed sheets is equal to or larger than the start condition (YES in Act 204), the CPU 40 executes the image quality maintenance control for black (K) (Act 205). When the image quality maintenance control is executed, the cumulative number of printed sheets is reset.

When the image quality maintenance control is executed, the CPU 40 determines whether the printing ends (Act 206).

If the cumulative number of printed sheets is smaller than the start condition in Act 204 (NO in Act 204), the CPU 40 determines, without executing the image quality maintenance control for black (K), whether the printing ends (Act 206).

If it is determined in Act 206 that the printing does not end (NO in Act 206), the CPU 40 updates the number of printed sheets (e.g., N=1) stored in the RAM 47-2 to N=N+1 (e.g., N=1+1) (Act 207), increments the cumulative number of sheets by one, and executes monochrome printing for an N+1th sheet (e.g., a second sheet) (Act 203).

The CPU 40 repeats Acts 203 to 207 as appropriate until it is determined in Act 206 that the printing ends. If the number of printed sheets reaches the number of original documents, the CPU 40 determines that the printing ends (YES in Act 206).

If printing for the number of original documents ends, the CPU 40 ends the printing processing. When the printing processing is ended, the number of original documents and the number of printed sheets are reset.

If the printing mode is the color printing mode as a result of the discrimination of the printing mode in Act 201, the color copying machine 10 forms a color copy image in the image quality priority mode in the same manner as in the monochrome printing mode.

Specifically, the color copying machine 10 starts color printing for a first sheet (Act 208) and the CPU 40 executes the color printing for the first sheet (Act 209). Then, the CPU 40 determines whether the cumulative number of printed sheets is equal to or larger than the start condition for the image quality maintenance control (Act 210). If the cumulative number of printed sheets is equal to or larger than the start condition for the image quality maintenance control as a result of the determination (YES in Act 210), the CPU 40 executes the image quality maintenance control for the colors (yellow (Y), magenta (M), and cyan (C)) (Act 211) and determines whether the printing ends (Act 212). If the cumulative number of printed sheets is smaller than the start condition for the image quality maintenance control (NO in Act 210), the CPU determines, without executing the image quality maintenance control, whether the printing ends (Act 212). If it is determined that the printing does not end (NO in Act 212), the CPU 40 updates the number of printed sheets of 1 stored in the RAM 47-2 to 1+1 (Act 213) and, at the same time, increments the cumulative number of printed sheets by one. The CPU 40 repeats Acts 203 to 207 as appropriate until it is determined in Act 212 that the printing ends. If it is determined that the printing ends (YES in Act 212), the CPU 40 ends the printing processing.

The image forming method performed if the toner cartridge 19K is a genuine product and at least one of the toner cartridges 19Y, 19M, and 19C is a non-genuine product is explained with reference to FIG. 6.

If it is determined as a result of the discrimination in Act 103 shown in FIG. 4 that at least one of toner cartridges 19Y, 19M, and 19C for yellow (Y), magenta (M), and cyan (C) is a non-genuine product, as shown in FIG. 6, the CPU 40 discriminates whether the printing mode is the monochrome printing mode (Act 301).

If the printing mode is the monochrome printing mode as a result of the discrimination of the printing mode in Act 301 (YES in Act 301), the color copying machine 10 forms a copy image in the normal mode. If the printing mode is the color printing mode (NO in Act 301), the color copying machine 10 forms a copy image in the image quality priority mode.

Specifically, if the printing mode is the monochrome printing mode (YES in Act 301), the color copying machine 10 starts color printing for a first sheet (Act 302) and the CPU 40 executes the color printing for the first sheet (Act 303). Then, the CPU 40 determines whether the printing ends (Act 304). If it is determined that the printing does not end (NO in Act 304), the CPU 40 updates the number of printed sheets of 1 stored in the RAM 47-2 to 1+1 (Act 305) and, at the same time, increments the cumulative number of printed sheets by one. The CPU 40 repeats Acts 305, 303, and 304 until it is determined in Act 304 that the printing ends. If it is determined that the printing ends as a result of the determination (YES in Act 304), the CPU 40 determines whether the cumulative number of printed sheets is equal to or larger than the start condition for the image quality maintenance control (Act 306). If the cumulative number of printed sheets is equal to or larger than the start condition for the image quality maintenance control as a result of the determination (YES in Act 306), the CPU 40 executes the image quality maintenance control for black (K) (Act 307) and ends the printing processing. If the cumulative number of printed sheets is smaller than the start condition for the image quality maintenance control (NO in Act 306), the CPU 40 ends the printing processing without executing the image quality maintenance control.

If the printing mode is the color printing mode (NO in Act 301), the color copying machine 10 starts color printing for a first sheet (Act 308) and the CPU 40 executes the color printing for the first sheet (Act 309). Then, the CPU 40 determines whether the cumulative number of printed sheets is equal to or larger than the start condition for the image quality maintenance control (Act 310). If the cumulative number of printed sheets is equal to or larger than the start condition for the image quality maintenance control (YES in Act 310), the CPU 40 executes the image quality maintenance control for the colors (yellow (Y), magenta (M), and cyan (C)) (Act 311) and determines whether the printing ends (Act 312). If the cumulative number of printed sheets is smaller than the start condition for the image quality maintenance control (NO in Act 310), the CPU 40 determines, without executing the image quality maintenance control, whether the printing ends (Act 312). If it is determined that the printing does not end (NO in Act 312), the CPU 40 updates the number of printed sheets of 1 stored in the RAM 47-2 to 1+1 (Act 313) and, at the same time, increments the cumulative number of printed sheets by one. The CPU 40 repeats Acts 303 to 307 as appropriate until it is determined in Act 312 that the printing ends. If it is determined that the printing ends (YES in Act 312), the CPU 40 ends the printing processing.

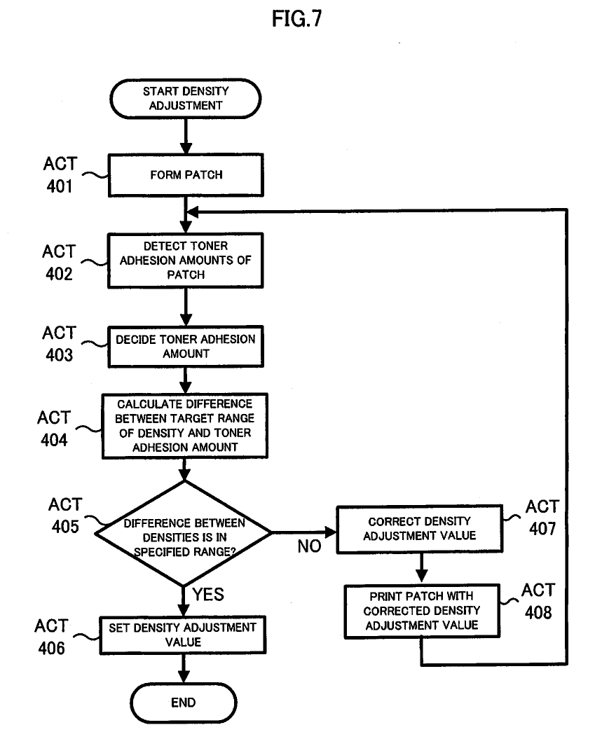

The image forming method according to this embodiment is explained above. However, a method of the image quality maintenance control is not limited in the image forming method. In the image quality maintenance control, for example, the photoconductive member cleaners 18Y, 18M, 18C, and 18K may be controlled to remove the toners remaining on the surfaces of the photoconductive drums 15Y, 15M, 15C, and 15K. As explained below, in the image quality maintenance control, density adjustment for an image may be performed. A method of executing the density adjustment for an image is explained below with reference to FIGS. 7 to 9.

FIG. 7 is a flowchart for explaining a density adjusting method. In the following explanation, the density adjusting method for black (K) is explained. However, the density adjustment method for the other colors (yellow (Y), magenta (M), and cyan (C)) is the same.

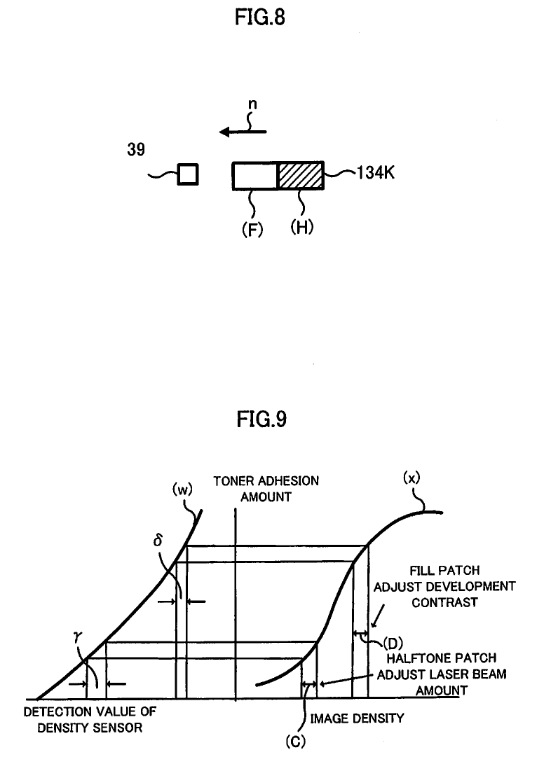

As shown in FIG. 7, when the density adjustment for an image is started, the image forming station 12Y forms, on the basis of the density adjustment pattern information stored in the ROM 47-1, a density adjustment pattern for black (K) on the transfer belt 14 (Act 401). As shown in FIG. 8, the density adjustment pattern for black (K) is a patch 134K of black (K) including a fill patch (F) and a halftone patch (H).

Subsequently, as shown in FIG. 7, the toner adhesion amount sensor 39 detects toner adhesion amounts on the fill patch (F) and the halftone patch (H) of the patch 134K (Act 402). The toner adhesion sensor 39 detects, for example, toner adhesion amounts at ten points on each of the fill patch (F) and the halftone patch (H).

An arithmetic operation unit 48 calculates an average of detection values of the toner adhesion amount sensor 39 and decides a toner adhesion amount (Act 403).

The arithmetic operation unit 48 calculates a difference between the target range of density of black (K) stored in the ROM 47-1 and the decided toner adhesion amount of black (K) (Act 404).

A relation between a detection value of the toner adhesion amount sensor 39 and a toner adhesion amount and density on the transfer belt 14 is shown in FIG. 9. A solid line (w) indicates the detection value of the toner adhesion amount sensor 39. A solid line (x) indicates the toner adhesion amount on the transfer belt 14. A range of the detection value of the toner adhesion amount sensor 39 is determined according to a target range of image density with reference to FIG. 9. For example, if the target range of density of the halftone patch (H) is (C), the range of the detection value of the toner adhesion amount sensor 39 is determined as (γ). If the target range of density of the fill patch (F) is (D), the range of the detection value of the toner adhesion amount sensor 39 is determined as (δ).

The CPU 40 discriminates from a result of the calculation in Act 404 whether the difference between the densities is within a specified range (Act 405). If the difference between the densities is within the specified range (YES in Act 405), the CPU 40 sets, in the exposing device 20, the electrifying chargers 16Y, 16M, 16C, and 16K, and the developing devices 17Y, 17M, 17C, and 17K, a density adjustment value at the time when the patch 134K is formed (Act 406).

If the difference between the densities exceeds the specified range as a result of the discrimination in Act 405 (NO in Act 405), the CPU 40 corrects the density adjustment value to set the difference between the densities within the specified range (Act 407).

As in Act 401, the CPU 40 forms the patch 134K on the transfer belt 14 using the corrected density adjustment value (Act 408).

Thereafter, the CPU 40 repeats Acts 407, 408, 402, 403, 404, and 405 in this order until it is discriminated in Act 405 that the difference between the densities is within the specified range. As a result of the repetition, if it is discriminated in Act 405 that the difference between the densities is within the specified range, the CPU 40 sets the corrected density adjustment value at that point in the exposing device 20, the electrifying chargers 16Y, 16M, 16C, and 16K, and the developing devices 17Y, 17M, 17C, and 17K (Act 406).

If the density adjustment value is set, the belt cleaner 32 removes the patch 134K on the transfer belt 14.

The setting of the density adjustment value is executed for each of the colors. However, if patches of the respective colors are simultaneously printed on the transfer belt 14 and are respectively read by four toner adhesion amount sensors 39 corresponding to the patches, it is possible to reduce time required for the setting of density adjustment values for the respective colors, i.e., the image quality maintenance control.

With the image forming apparatus and the image forming method according to this embodiment explained above, only when it is likely that a copy image is formed using the non-genuine cartridges 19Y, 19M, 19C, and 19K, the frequency of execution of the image quality maintenance control is increased. Therefore, since execution frequency of the image quality maintenance control is not unnecessarily increased, waiting time for the user until a copy image is formed after an original document is read can be suppressed from increasing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
plural toner cartridges including therein toners of colors different from one another;
a discriminating unit configured to discriminate whether the plural toner cartridges are respectively genuine products;
a printing-mode selecting unit configured to select single-color printing for forming a copy image formed of a single color or plural-color printing for forming a copy image formed of plural colors; and
an image forming unit configured to form, if the discriminating unit discriminates that the toner cartridge used in the single-color printing is a non-genuine product or if the discriminating unit discriminates that at least one of the plural toner cartridges used in the plural-color printing is a non-genuine product and the printing-mode selecting unit selects the plural-color printing, a copy image in an image quality priority mode for executing, at a frequency higher than that in a normal mode, image quality maintenance control for maintaining the copy image in desired image quality.

2. The apparatus according to claim 1, further comprising:
a storage device having stored therein product information for specifying that the toner cartridge is a genuine product; and
a cartridge discrimination sensor configured to read the product information stored in the storage device, wherein
the discriminating unit discriminates, on the basis of the product information read by the cartridge discrimination sensor, whether the toner cartridge is a genuine product.

3. The apparatus according to claim 2, wherein the storage device is provided on an end face of the toner cartridge.

4. The apparatus according to claim 1, further comprising:
plural convex portions provided on the toner cartridge in order to specify that the toner cartridge is a genuine product; and
a cartridge discrimination sensor configured to detect a distance among the plural convex portions, wherein
the discriminating unit discriminates, on the basis of the distance among the plural convex portions detected by the cartridge discrimination sensor, whether the toner cartridge is a genuine product.

5. The apparatus according to claim 4, wherein the plural convex portions are provided on an end face of the toner cartridge.

6. The apparatus according to claim 1, wherein the printing-mode selecting unit is an operation panel.

7. The apparatus according to claim 1, wherein
the image forming unit includes plural image forming stations including:
image bearing members on surfaces of which electrostatic latent images are formed;
developing devices configured to supply toners to the surfaces of the image bearing members to thereby form toner images on the surfaces of the image bearing members; and
photoconductive member cleaners configured to remove the toners on the surfaces of the image bearing members, and
in the image quality maintenance control, the copy image is maintained in desired image quality by controlling the photoconductive member cleaners.

8. The apparatus according to claim 1, wherein
the image forming unit includes plural image forming stations including:
image bearing members;
electrifying chargers configured to uniformly charge the surfaces of the image bearing members;
exposing devices configured to irradiate laser beams on the surfaces of the image bearing members to thereby form electrostatic latent images on the surfaces of the image bearing members; and
developing devices configured to supply toners to the surfaces of the image bearing members to thereby form toner images on the surfaces of the image bearing members, and
in the image quality maintenance control, the copy image is maintained in desired image quality by controlling the plural image forming stations to control density of the copy image.

9. The apparatus according to claim 8, further comprising:
a conveying unit configured to convey a sheet on which the copy image is formed; and
a toner adhesion amount sensor configured to detect density of a density adjustment pattern formed on the conveying unit by the image forming unit, wherein
in the image quality maintenance control, the plural image forming stations are controlled on the basis of a result of detection of density of the density adjustment pattern by the toner adhesion amount sensor.

10. The apparatus according to claim 1, wherein
the plural toner cartridges are toner cartridges for four colors of yellow, magenta, cyan, and black, and
the image forming unit forms, if the discriminating unit discriminates that the toner cartridge for black used in the single-color printing is a non-genuine product or if the discriminating unit discriminates that at least one of the toner cartridge for yellow, the toner cartridge for magenta, and the toner cartridge for cyan used in the plural-color printing is a non-genuine product and the printing-mode selecting unit selects the plural-color printing, a copy image in the image quality priority mode for executing, at a frequency higher than that in the normal mode, the image quality maintenance control for maintaining the copy image in desired image quality.

11. An image forming method comprising:
discriminating whether plural toner cartridges including therein toners of colors different from one another are respectively genuine products;
selecting single-color printing for forming a copy image formed of a single color or plural-color printing for forming a copy image formed of plural colors; and
forming, if it is discriminated that the toner cartridge used in the single-color printing is a non-genuine product or if it is discriminated that at least one of the plural toner cartridges used in the plural-color printing is a non-genuine product and the plural-color printing is selected, a copy image in an image quality priority mode for executing, at a frequency higher than that in a normal mode, image quality maintenance control for maintaining the copy image in desired image quality.

12. The method according to claim 11, further comprising reading product information for specifying that the toner cartridge is a genuine product, the product information being stored in a storage device of the toner cartridge, wherein
the discriminating includes discriminating, on the basis of the product information read in the reading, whether the toner cartridge is a genuine product.

13. The method according to claim 12, wherein the storage device is provided on an end face of the toner cartridge.

14. The method according to claim 11, further comprising detecting a distance among plural convex portions provided in the toner cartridge, wherein
the discriminating includes discriminating, on the basis of the distance among the plural convex portions detected in the detecting, whether the toner cartridge is a genuine product.

15. The method according to claim 14, wherein the plural convex portions are provided on an end face of the toner cartridge.

16. The method according to claim 11, wherein, in the selecting, a user selects the single-color printing or the plural-color printing by operating an operation panel.

17. The method according to claim 11, wherein
the forming a copy image includes:
supplying toners to surfaces of image bearing members on which electrostatic latent images are formed; and
removing the toners on the surfaces of the image bearing members, and
in the image quality maintenance control, the copy image is maintained in desired image quality by controlling removal amounts of the toners on the surfaces of the image bearing members in the removing.

18. The method according to claim 11, wherein
the forming a copy image includes:
uniformly charging the surfaces of the image bearing members;
irradiating laser beams on the surfaces of the image bearing members to thereby form electrostatic latent images on the surfaces of the image bearing members; and
supplying toners to the surfaces of the image bearing members to thereby form toner images on the surfaces of the image bearing members, and
in the image quality maintenance control, the copy image is maintained in desired image quality by controlling charging amounts on the surfaces of the image bearing members in the uniformly charging the surfaces of the image bearing members, potentials of the electrostatic latent images in the irradiating laser beams, and toner supply amounts in the supplying toners.

19. The method according to claim 18, further comprising detecting density of a density adjustment pattern formed on a conveying unit configured to convey a sheet, wherein
in the image quality maintenance control, the charging amounts on the surfaces of the image bearing members in the uniformly charging the surfaces of the image bearing members, the potentials of the electrostatic latent images in the irradiating laser beams, and the toner supply amounts in the supplying toners are controlled on the basis of a result of the detection of the density of the density adjustment pattern in the detecting density of the density adjustment pattern.

20. The method according to claim 11, wherein
the plural toner cartridges are toner cartridges for four colors of yellow, magenta, cyan, and black, and
in the forming a copy image, if it is discriminated that the toner cartridge for black used in the single-color printing is a non-genuine product or if it is discriminated that at least one of the toner cartridge for yellow, the toner cartridge for magenta, and the toner cartridge for cyan used in the plural-color printing is a non-genuine product and the plural-color printing is selected, the copy image is formed in the image quality priority mode for executing, at a frequency higher than that in the normal mode, the image quality maintenance control for maintaining the copy image in desired image quality.
